(19) United States
(12) Patent Application Publication
(10) Pub. No.: US 2021/0188311 A1
(43) Pub. Date: Jun. 24, 2021

(54) ARTIFICIAL INTELLIGENCE MOBILITY DEVICE CONTROL METHOD AND INTELLIGENT COMPUTING DEVICE CONTROLLING AI MOBILITY

(71) Applicant: LG ELECTRONICS INC., Seoul (KR)

(72) Inventor: Eunsun CHO, Seoul (KR)

(73) Assignee: LG ELECTRONICS INC., Seoul (KR)

(21) Appl. No.: 17/028,695

(22) Filed: Sep. 22, 2020

(30) Foreign Application Priority Data
Dec. 24, 2019 (KR) 10-2019-0174472

(51) Int. Cl. B60W 60/00; B60W 40/09; B60W 40/06; G08G 1/052; B60W 30/095; G08G 1/16; H04W 4/40; H04W 4/38; H04W 4/02; H04W 72/04; H04L 5/00; G06K 9/00; G06K 9/46; G06K 9/62; G06N 20/00; G06N 3/08

(52) U.S. Cl. CPC B60W 60/001; B60W 2030/082; B60W 40/06; G08G 1/052; B60W 60/0051; B60W 60/0059; B60W 30/0956; G08G 1/162; H04W 4/40; H04W 4/38; H04W 4/02; H04W 72/042; H04L 5/0048; G06K 9/00791; G06K 9/00845; G06K 9/46; G06K 9/6256; G06N 20/00; G06N 3/08; B60W 2540/30; B60W 2540/223; B60W 2420/42; B60W 2520/105; B60W 2556/45; B60W 40/09

(57) ABSTRACT

A method of controlling an artificial intelligence (AI) mobility device can include acquiring personal information of a driver and setting a driving level based on the personal information of the driver; acquiring driving information of the driver based on the driving level while the driver is driving; determining a skill status of the driver based on the driving information of the driver; applying road information corresponding to the skill status of the driver; and in response to determining that the skill status of the driver is lower than a predetermined reference based on the road information, outputting a warning and executing a function of the AI mobility device based on the warning.

### CROSS REFERENCE TO RELATED APPLICATIONS

This application claims the priority benefit of Korean Patent Application No. 10-2019-0174472, filed in the Republic of Korea on Dec. 24, 2019, which is incorporated herein by reference for all purposes as if fully set forth herein.

### BACKGROUND OF THE INVENTION

### Field of the Invention

The present disclosure relates to an artificial intelligence (AI) mobility device control method and an intelligent computing device controlling AI mobility, and more particularly, to an AI mobility device control method capable of guiding stable driving by learning various data imaged while driving and an intelligent computing device for controlling AI mobility.

### Related Art

Recently, the global trend shows that a sharing economy using surplus resources has come to prominence as a paradigm of a new era and its value is evidenced by a variety of business models using it. Among them, a smart mobility industry related to transportation has newly received attention. In a dictionary definition, smart mobility is used as a next-generation personal transportation vehicle powered by electric power, such as electric bicycles, electric wheels, and electric kickboards in a narrow sense, and from the users' perspective, smart mobility refers to enjoying work, leisure, and social activities, while moving quickly and safely to a desired destination using a smartphone.

Research into smart mobility has been actively conducted to minimize traffic congestion that hinders existing road efficiency and to expand road capacity and ultimately provide users with an unobstructed road driving environment.

### SUMMARY OF THE INVENTION

The present disclosure provides an artificial intelligence (AI) mobility device control method capable of guiding stable driving by learning various data imaged while driving, and an intelligent computing device for controlling AI mobility.

Technical objects to be achieved by the present invention are not limited to the aforementioned technical objects, and other technical objects not described above may be evidently understood by a person having ordinary skill in the art to which the present invention pertains from the following description.

In an aspect, a method of controlling an artificial intelligence (AI) mobility device can include acquiring basic information of a driver and setting a driving level based on the basic information of the driver; acquiring driving information of the driver based on the driving level while the driver is driving; determining a skill status of the driver based on the driving information of the driver; applying road information corresponding to the skill status of the driver; and outputting a warning if the skill status of the driver who is driving is determined to be lower than a predetermined reference based on the road information, and controlling the AI mobility device according to the warning.

The driving information of the driver can be extracted from at least one of a driving style of the driver, a driving habit of the driver, and a driving posture of the driver acquired by analyzing a camera image.

The determining of the skill status of the driver can include extracting feature values from the driving information acquired through at least one sensor; and inputting the feature values to an artificial neural network (ANN) classifier trained to distinguish the skill status of the driver and determining the skill status of the driver from an output of the ANN.

The feature values can be values for distinguishing the skill status of the driver, and the values for distinguishing the skill status of the driver can include at least one of a quick start, a sudden stop, a speed violation, a lane change, acceleration, sudden deceleration, a vibration strength, and a vibration number.

The applying of the road information corresponding to the skill status of the driver can include applying road information for a beginner if the skill status of the driver is determined to correspond to the beginner; applying road information for an intermediate if the skill status of the driver is determined to correspond to the intermediate rather than the beginner; and applying road information for an advanced driver if the skill status of the driver is determined to correspond to the advanced driver rather than the intermediate.

The method can further include outputting a warning signal if the skill status of the driver is determined to be lower than the predetermined reference; and controlling the AI mobility device according to the warning signal.

The method can further include acquiring, if the skill status of the driver is low, road information and sensing information collected in real time and performing control to guide the AI mobility device to a safe region excluding a preset danger zone.

The method can further include switching, if the skill status of the driver is low, the AI mobility device driven in a manual driving mode to an artificial intelligence (AI) driving mode; moving the AI mobility device to a safe region using the AI driving mode; and depriving of or stopping the driver's authority to control driving or performing control to reset to a driving mode corresponding to a driving skill status of the driver.

The method can further include detecting, if an accident occurs while the AI mobility device is driving, a location of the accident through a sensor disposed in the AI mobility device; and sending the location of the accident and a notification text to a preset guardian.

The method can further include transmitting a V2X message including information related to a driving state of the driver to another terminal communicatively connected to the AI mobility device.

The method can further include receiving, from a network, downlink control information (DCI) used for scheduling transmission of the driving information of the driver acquired from at least one sensor, in which the driving information of the driver is transmitted to the network based on the DCI.

The method can further include performing an initial access procedure with the network based on a synchronization signal block (SSB), in which the driving information of the driver is transmitted to the network via a physical uplink shared channel (PUSCH), and the SSB and a demodulation reference signal (DM-RS) of the PUSCH are quasi-co-located (QCL) for a QCL type D.

The method can further include controlling a transceiver to transmit the driving information of the driver to an AI processor included in the network; and controlling the transceiver to receive AI-processed information from the AI processor.

In another aspect, an intelligent computing device for controlling an artificial intelligence (AI) mobility device can include a camera provided in the AI mobility device; a sensing unit including at least one sensor; a processor; and a memory including an instruction executable by the processor, in which the processor is configured to acquire basic information of a driver, to set a driving level based on the basic information of the driver, to acquire driving information of the driver based on the driving level while the driver is driving, to determine a skill status of the driver based on the driving information of the driver, to apply road information corresponding to the skill status of the driver, to output a warning if the skill status of the driver who is driving is determined to be lower than a predetermined reference based on the road information, and to control the AI mobility device according to the warning.

The processor can be configured to extract feature values from the driving information of the driver acquired through at least one sensor, to input the feature values to an artificial neural network (ANN) classifier trained to distinguish the skill status of the driver, and to determine the skill status of the driver from an output of the ANN, in which the feature values are values for distinguishing the skill status of the driver.

The intelligent computing device can further include a transceiver, in which the processor is configured to control the transceiver to transmit the driving information of the driver to an AI processor included in the network and to receive AI-processed information from the AI processor, and the AI-processed information is information for determining a skill status of the driver.

The processor can be configured to map sensing information acquired through the sensor to map information, to extract road information and information of a region including a dangerous factor for the AI mobility device to drive, using the map information, and to set a region of interest (ROI) for object tracking based on the information of the region including the dangerous factor for the AI mobility device to drive, in which the ROI includes a geographical range to be monitored for the AI mobility device to drive.

The processor can be configured to apply road information corresponding to the skill status of the driver, in which the processor is configured to apply road information for a beginner if the skill status of the driver is determined to correspond to the beginner, to apply road information for an intermediate if the skill status of the driver is determined to correspond to the intermediate rather than the beginner, and to apply road information for an advanced driver if the skill status of the driver is determined to correspond to the advanced driver rather than the intermediate.

The processor can be configured to output a warning signal if the skill status of the driver is determined to be lower than the predetermined reference, and the processor is configured to control the AI mobility device according to the warning signal.

The processor can be configured to detect, if an accident occurs while the AI mobility device is driving, a location of the accident through the sensor and to perform control to send the location of the accident and a notification text to a preset guardian.

### BRIEF DESCRIPTION OF THE DRAWINGS

FIG. 1 is a block diagram of a wireless communication system to which the methods proposed in the present disclosure may be applied according to an embodiment of the present disclosure.

FIG. 2 shows an example of a signal transmission/reception method in a wireless communication system according to an embodiment of the present disclosure.

FIG. 3 shows an example of a basic operation of an artificial intelligence (AI) mobility device and a 5G network in a 5G communication system according to an embodiment of the present disclosure.

FIG. 4 shows an example of a basic operation between an AI mobility device and an AI mobility device using 5G communication according to an embodiment of the present disclosure.

FIG. 5 is a diagram illustrating an AI mobility device according to an embodiment of the present disclosure.

FIG. 6 is a control block diagram of an AI mobility device according to an embodiment of the present disclosure.

FIG. 7 is a control block diagram of an AI autonomous device according to an embodiment of the present disclosure.

FIG. 8 is a signal flow diagram of an AI mobility device according to an embodiment of the present disclosure.

FIG. 9 is a diagram referred to for illustrating a usage scenario of a user according to an embodiment of the present disclosure.

FIG. 10 is an example of V2X communication to which the present disclosure may be applied according to an embodiment of the present disclosure.

FIG. 11, including parts (a) and (b), illustrates a resource allocation method in a sidelink in which V2X is used according to an embodiment of the present disclosure.

FIG. 12 is a diagram illustrating a procedure for a broadcast mode of V2X communication using PC5 according to an embodiment of the present disclosure.

FIG. 13 is a block diagram of an AI device according to an embodiment of the present disclosure.

FIG. 14 is a flowchart of an AI mobility device control method according to an embodiment of the present disclosure.

FIG. 15 is a diagram illustrating an example of determining a skilled status of a driver according to an embodiment of the present disclosure.

FIG. 16 is a diagram illustrating another example of determining a skilled status of a driver according to an embodiment of the present disclosure.

FIG. 17 is a diagram illustrating a specific example of setting road information in response to a skilled status of a driver in an embodiment of the present disclosure

FIG. 18 is an embodiment to which the present disclosure may be applied.

FIG. 19 is an embodiment of a method of setting a region of interest (ROI) to which the present disclosure may be applied.

FIG. 20 is an embodiment of an object tracking algorithm to which the present disclosure may be applied.

FIG. 21 illustrates a method of controlling according to a skilled status of a driver that may be applied to the present disclosure according to an embodiment of the present disclosure.

FIG. 22 illustrates an example of a method of controlling AI mobility that may be applied to the present disclosure according to an embodiment.

FIG. 23 illustrates another example of a method of controlling AI mobility that may be applied to the present disclosure according to an embodiment.

FIG. 24 illustrates an example of a method of controlling AI mobility that may be applied to the present disclosure according to an embodiment.

FIG. 25 is a general example of a device to which the present disclosure may be applied according to an embodiment.

### DETAILED DESCRIPTION OF THE EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first,” “second,” etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

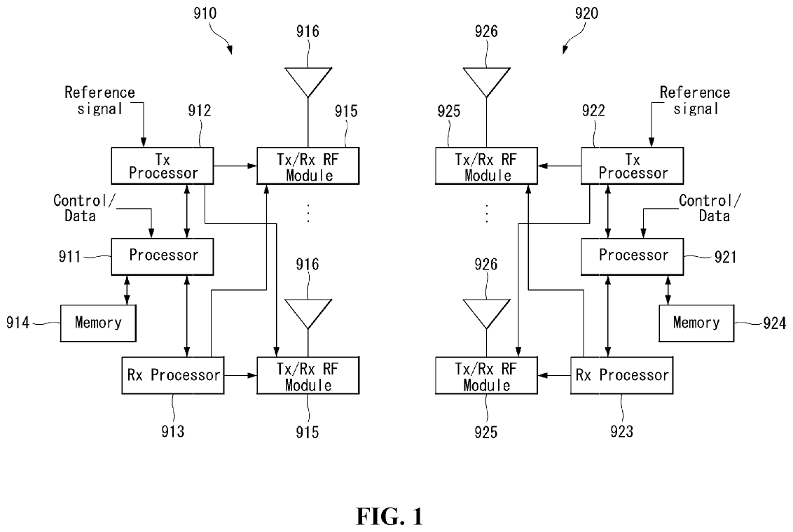

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

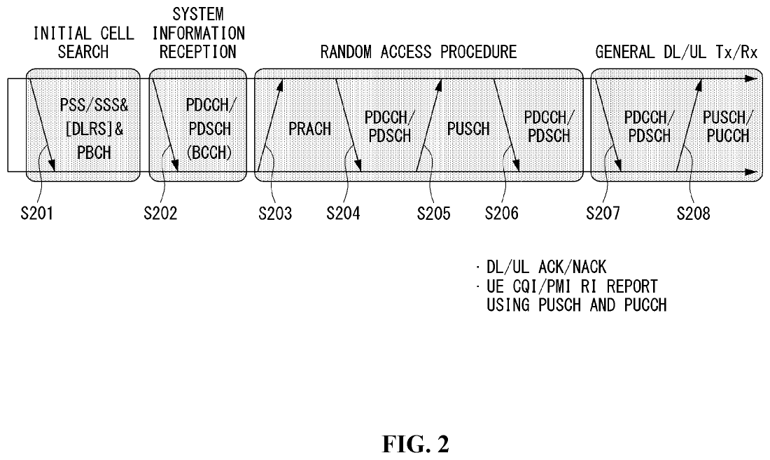

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission based on DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement based on an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission based on most recent pathloss and a power ramping counter.

The UE can perform UL transmission through Msg3 of the random access procedure over a physical uplink shared channel based on the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS based on the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted based on SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequency Sect.

The UE receives DCI format 2_1 from the BS based on the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data based on signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between AI Mobility Devices Using 5G Communication

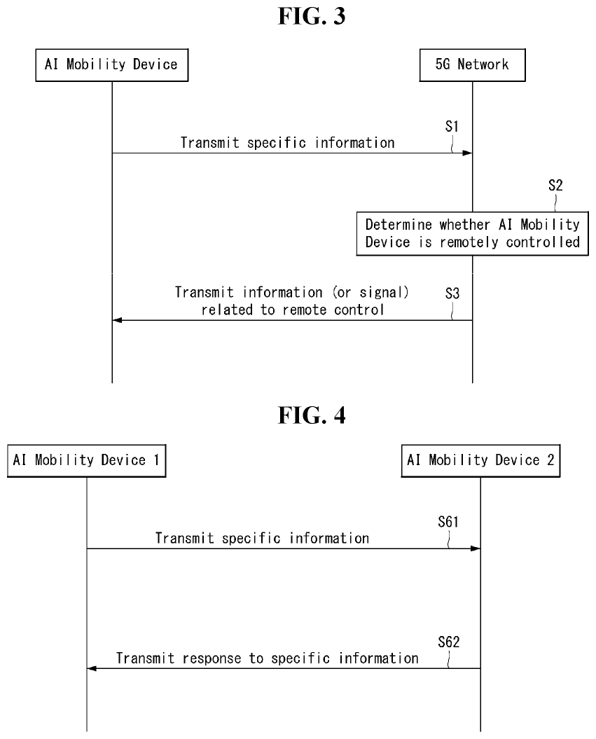

FIG. 3 shows an example of basic operations of an AI mobility device and a 5G network in a 5G communication system.

The AI mobility device transmits specific information to the 5G network (S1). The specific information may include autonomous driving related information. In addition, the 5G network can determine whether to remotely control the AI mobility device (S2). Here, the 5G network may include a server or a module which performs remote control related to autonomous driving. In addition, the 5G network can transmit information (or signal) related to remote control to the AI mobility device (S3).

G. Applied Operations Between AI Mobility Devices and 5G Network in 5G Communication System

Hereinafter, the operation of an AI mobility device using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the AI mobility devices performs an initial access procedure and a random access procedure with the 5G network prior to step S1 of FIG. 3 in order to transmit/receive signals, information and the like to/from the 5G network.

More specifically, the AI mobility devices performs an initial access procedure with the 5G network based on an SSB in order to acquire DL synchronization and system information. A beam management (BM) procedure and a beam failure recovery procedure may be added in the initial access procedure, and quasi-co-location (QCL) relation may be added in a process in which the AI mobility devices receives a signal from the 5G network.

In addition, the AI mobility devices performs a random access procedure with the 5G network for UL synchronization acquisition and/or UL transmission. The 5G network can transmit, to the AI mobility device, a UL grant for scheduling transmission of specific information. Accordingly, the AI mobility device transmits the specific information to the 5G network based on the UL grant. In addition, the 5G network transmits, to the AI mobility device, a DL grant for scheduling transmission of 5G processing results with respect to the specific information. Accordingly, the 5G network can transmit, to the AI mobility device, information (or a signal) related to remote control based on the DL grant.

Next, a basic procedure of an applied operation to which a method proposed by the present disclosure which will be described later and URLLC of 5G communication are applied will be described.

As described above, an AI mobility device can receive DownlinkPreemption IE from the 5G network after the AI mobility device performs an initial access procedure and/or a random access procedure with the 5G network. Then, the AI mobility device receives DCI format 2_1 including a preemption indication from the 5G network based on DownlinkPreemption IE. The AI mobility device does not perform (or expect or assume) reception of eMBB data in resources (PRBs and/or OFDM symbols) indicated by the preemption indication. Thereafter, when the AI mobility device needs to transmit specific information, the AI mobility device can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the AI mobility device receives a UL grant from the 5G network in order to transmit specific information to the 5G network. Here, the UL grant may include information on the number of repetitions of transmission of the specific information and the specific information may be repeatedly transmitted based on the information on the number of repetitions. That is, the AI mobility device transmits the specific information to the 5G network based on the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between AI Mobility Devices Using 5G Communication

FIG. 4 shows an example of a basic operation between vehicles using 5G communication.

An AI mobility device 1 transmits specific information to an AI mobility device 2 (S61). The AI mobility device 2 transmits a response to the specific information to the AI mobility device 1 (S62).

Meanwhile, a configuration of an applied operation between AI mobility devices may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the AI mobility device 1 for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the AI mobility device 1 transmits SCI format 1 for scheduling of specific information transmission to the AI mobility device 2 over a PSCCH. Then, the first vehicle transmits the specific information to the AI mobility device 2 over a PSSCH.

Next, a method in which a 5G network is indirectly involved in resource allocation for signal transmission/reception will be described.

The AI mobility device 1 senses resources for mode-4 transmission in a first window. Then, the AI mobility device 1 selects resources for mode-4 transmission in a second window based on the sensing result. Here, the first window refers to a sensing window and the second window refers to a selection window. The AI mobility device 1 transmits SCI format 1 for scheduling of transmission of specific information to the AI mobility device 2 over a PSCCH based on the selected resources. Then, the AI mobility device 1 transmits the specific information to the AI mobility device 2 over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

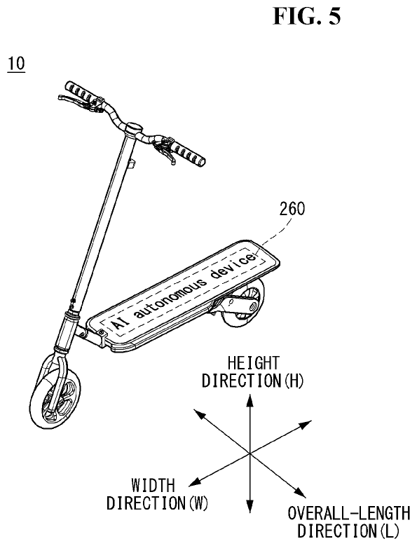

FIG. 5 is a diagram showing an AI mobility device according to an embodiment of the present disclosure.

Referring to FIG. 5, an AI mobility device 10 according to an embodiment of the present disclosure is defined as a transportation means traveling on roads or railroads. The AI mobility device 10 includes a car, a train and a motorcycle. The AI mobility device 10 may include an internal-combustion engine vehicle having an engine as a power source, a hybrid vehicle having an engine and a motor as a power source, and an electric vehicle having an electric motor as a power source. The AI mobility device 10 may be a privately owned AI mobility device. The AI mobility device 10 may be a shared vehicle. The AI mobility device 10 may be an Autonomous vehicle.

(2) Components of AI Mobility Device

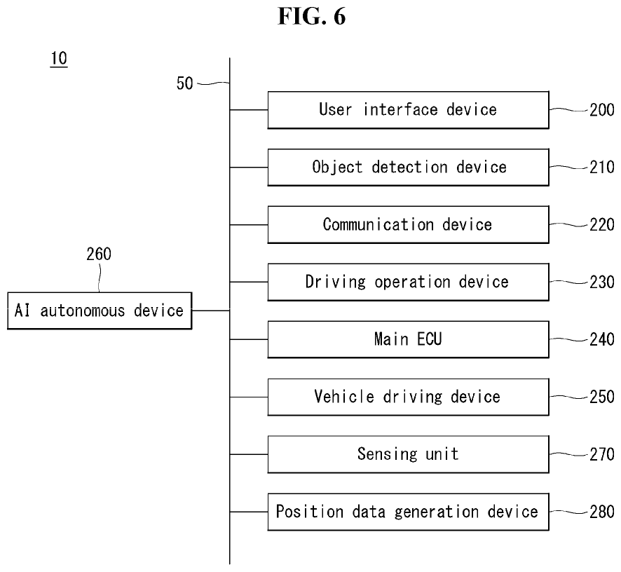

FIG. 6 is a control block diagram of the AI mobility device according to an embodiment of the present disclosure.

Referring to FIG. 6, the AI mobility device 10 may include a user interface device 200, an object detection device 210, a communication device 220, a driving operation device 230, a main ECU 240, a driving control device 250, an AI autonomous device 260, a sensing unit 270, and a position data generation device 280. The object detection device 210, the communication device 220, the driving operation device 230, the main ECU 240, the driving control device 250, the AI autonomous device 260, the sensing unit 270 and the position data generation device 280 may be realized by electronic devices which generate electric signals and exchange the electric signals from one another.

1) User Interface Device

The user interface device 200 is a device for communication between the AI mobility device 10 and a user. The user interface device 200 can receive user input and provide information generated in the AI mobility device 10 to the user. The AI mobility device 10 can realize a user interface (UI) or user experience (UX) through the user interface device 200. The user interface device 200 may include an input device, an output device and a user monitoring device.

2) Object Detection Device

The object detection device 210 can generate information about objects outside the AI mobility device 10. Information about an object can include at least one of information on presence or absence of the object, positional information of the object, information on a distance between the AI mobility device 10 and the object, and information on a relative speed of the AI mobility device 10 with respect to the object. The object detection device 210 can detect objects outside the AI mobility device 10. The object detection device 210 may include at least one sensor which can detect objects outside the AI mobility device 10. The object detection device 210 may include at least one of a camera, a radar, a lidar, an ultrasonic sensor and an infrared sensor. The object detection device 210 can provide data about an object generated based on a sensing signal generated from a sensor to at least one electronic device included in the vehicle.

2.1) Camera

The camera can generate information about objects outside the AI mobility device 10 using images. The camera may include at least one lens, at least one image sensor, and at least one processor which is electrically connected to the image sensor, processes received signals and generates data about objects based on the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image based on change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera based on disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object based on the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves based on TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the AI mobility device 10 using a laser beam. The lidar may include a light transmitter, a light receiver, and at least one processor which is electrically connected to the light transmitter and the light receiver, processes received signals and generates data about an object based on the processed signal. The lidar may be realized according to TOF or phase shift. The lidar may be realized as a driven type or a non-driven type. A driven type lidar may be rotated by a motor and detect an object around the AI mobility device 10. A non-driven type lidar may detect an object positioned within a predetermined range from the vehicle according to light steering. The AI mobility device 10 may include a plurality of non-drive type lidars. The lidar can detect an object through a laser beam based on TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the AI mobility device 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices based on C-V2X (Cellular V2X). For example, C-V2X can include sidelink communication based on LTE and/or sidelink communication based on NR. Details related to C-V2X will be described later.

For example, the communication device can exchange signals with external devices based on DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the AI mobility device 10 may be driven based on a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the AI mobility device 10.

6) Driving Control Device

The driving control device 250 is a device for electrically controlling various vehicle driving devices included in the AI mobility device 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices based on signals received by the AI autonomous device 260. For example, the driving control device 250 can control a power train, a steering device and a brake device based on signals received by the AI autonomous device 260.

7) AI Autonomous Device

The AI autonomous device 260 can generate a route for self-driving based on acquired data. The AI autonomous device 260 can generate a driving plan for traveling along the generated route. The AI autonomous device 260 can generate a signal for controlling movement of the AI autonomous device according to the driving plan. The AI autonomous device 260 can provide the signal to the driving control device 250.

The AI autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The AI autonomous device 260 can perform switching from a self-driving mode to a manual driving mode or switching from the manual driving mode to the self-driving mode. For example, the AI autonomous device 260 can switch the mode of the AI mobility device 10 from the self-driving mode to the manual driving mode or from the manual driving mode to the self-driving mode based on a signal received from the user interface device 200.

8) Sensing Unit

The sensing unit 270 can detect a state of the AI mobility device. The sensing unit 270 may include at least one of an internal measurement unit (IMU) sensor, a collision sensor, a wheel sensor, a speed sensor, an inclination sensor, a weight sensor, a heading sensor, a position module, an AI mobility device forward/backward movement sensor, a battery sensor, a fuel sensor, a tire sensor, a steering sensor, a temperature sensor, a humidity sensor, an ultrasonic sensor, and an illumination sensor. Further, the IMU sensor may include one or more of an acceleration sensor, a gyro sensor and a magnetic sensor.

The sensing unit 270 can generate AI mobility device state data based on a signal generated from at least one sensor. AI mobility device state data may be information generated based on data detected by various sensors included in the AI mobility device. The sensing unit 270 may generate AI mobility device attitude data, AI mobility device motion data, AI mobility device yaw data, AI mobility device roll data, AI mobility device pitch data, AI mobility device collision data, AI mobility device orientation data, AI mobility device angle data, AI mobility device speed data, AI mobility device acceleration data, AI mobility device tilt data, AI mobility device forward/backward movement data, AI mobility device weight data, battery data, fuel data, tire pressure data, AI mobility device internal temperature data, AI mobility device internal humidity data, steering wheel rotation angle data, AI mobility device external illumination data, data of a pressure applied to an acceleration pedal, data of a pressure applied to a brake panel, etc.

9) Position Data Generation Device

The position data generation device 280 can generate position data of the AI mobility device 10. The position data generation device 280 may include at least one of a global positioning system (GPS) and a differential global positioning system (DGPS). The position data generation device 280 can generate position data of the AI mobility device 10 based on a signal generated from at least one of the GPS and the DGPS. According to an embodiment, the position data generation device 280 can correct position data based on at least one of the inertial measurement unit (IMU) sensor of the sensing unit 270 and the camera of the object detection device 210. The position data generation device 280 may also be called a global navigation satellite system (GNSS).

The AI mobility device 10 may include an internal communication system 50. The plurality of electronic devices included in the AI mobility device 10 can exchange signals through the internal communication system 50. The signals may include data. The internal communication system 50 can use at least one communication protocol (e.g., CAN, LIN, FlexRay, MOST or Ethernet).

(3) Components of Autonomous Device

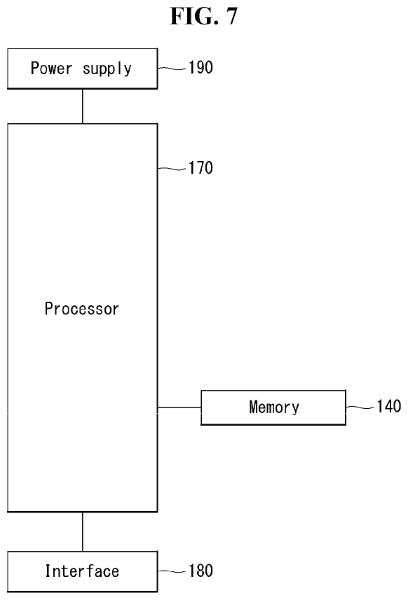

FIG. 7 is a control block diagram of the AI autonomous device according to an embodiment of the present disclosure.

Referring to FIG. 7, the AI autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the AI autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the AI mobility device 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the AI autonomous device 260. The power supply 190 can be provided with power from a power source (e.g., a battery) included in the AI mobility device 10 and supply the power to each unit of the AI autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the AI mobility device 10 through the interface 180. The processor 170 can provide control signals to other electronic devices in the AI mobility device 10 through the interface 180.

The AI autonomous device 260 may include at least one printed circuit board (PCB). The memory 140, the interface 180, the power supply 190 and the processor 170 may be electrically connected to the PCB.

(4) Operation of AI Autonomous Device

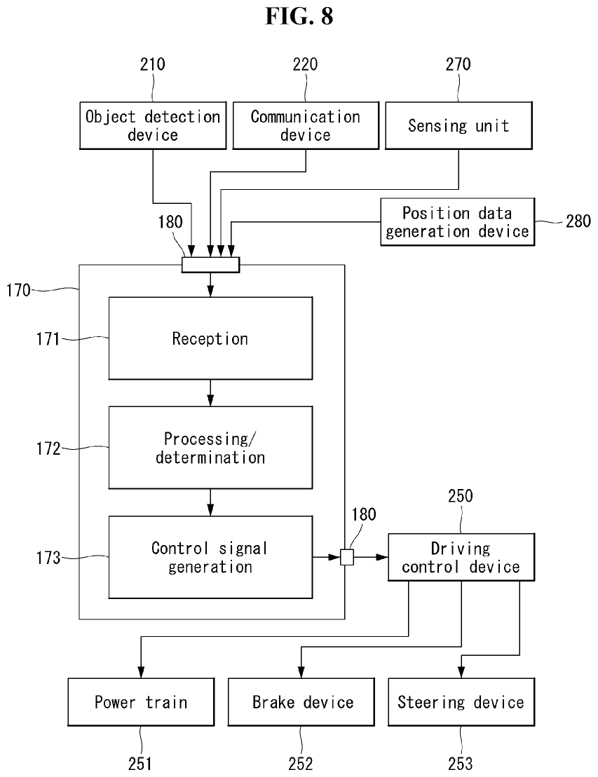

FIG. 8 is a diagram showing a signal flow in an AI mobility device according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive an AI mobility device state data from the sensing unit 270. The processor 170 can receive position data from the position data generation device 280.

2) Processing/Determination Operation

The processor 170 can perform a processing/determination operation. The processor 170 can perform the processing/determination operation based on traveling situation information. The processor 170 can perform the processing/determination operation based on at least one of object data, HD map data, AI mobility device state data and position data.

2.1) Driving Plan Data Generation Operation

The processor 170 can generate driving plan data. For example, the processor 170 may generate electronic horizon data. The electronic horizon data can be understood as driving plan data in a range from a position at which the AI mobility device 10 is located to a horizon. The horizon can be understood as a point a predetermined distance before the position at which the AI mobility device 10 is located based on a predetermined traveling route. The horizon may refer to a point at which the AI mobility device can arrive after a predetermined time from the position at which the AI mobility device 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of an AI mobility device and may have a data form used for navigation for drivers. The topology data may be understood as data about road information other than information on driveways. The topology data may be generated based on data received from an external server through the communication device 220. The topology data may be based on data stored in at least one memory included in the AI mobility device 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for AI mobility device localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the AI mobility device 10 is located to the horizon.

2.1.2) Horizon Path Data

The horizon path data may be explained as a trajectory through which the AI mobility device 10 can travel in a range from a position at which the AI mobility device 10 is located to the horizon. The horizon path data may include data indicating a relative probability of selecting a road at a decision point (e.g., a fork, a junction, a crossroad, or the like). The relative probability may be calculated based on a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at least one decision point on the main path.

3) Control Signal Generation Operation

The processor 170 can perform a control signal generation operation. The processor 170 can generate a control signal based on the electronic horizon data. For example, the processor 170 may generate at least one of a power train control signal, a brake device control signal and a steering device control signal based on the electronic horizon data.

The processor 170 can transmit the generated control signal to the driving control device 250 through the interface 180. The driving control device 250 can transmit the control signal to at least one of a power train 251, a brake device 252 and a steering device 254.

AI mobility device usage scenario

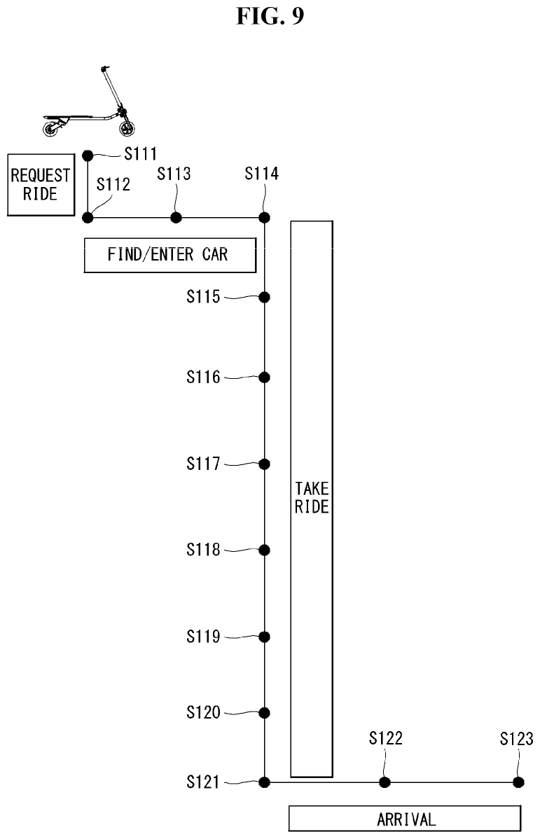

FIG. 9 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system can be installed in a user terminal. The user terminal can predict a destination of a user based on user's contextual information through the application. The user terminal can provide information on unoccupied seats in the cabin through the application.

2) Cabin Interior Layout Preparation Scenario

A second scenario S112 is a cabin interior layout preparation scenario. The cabin system may further include a scanning device for acquiring data about a user located outside the AI mobility device. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system can set a cabin interior layout based on at least one of the body data and baggage data of the user.

3) User Welcome Scenario

A third scenario S113 is a user welcome scenario. The cabin system may further include at least one guide light. The guide light can be disposed on the floor of the cabin. When a user riding in the AI mobility device is detected, the cabin system can turn on the guide light such that the user sits on seat.

4) Seat Adjustment Service Scenario

A fourth scenario S114 is a seat adjustment service scenario. The seat system can adjust at least one element of a seat that matches a user based on acquired body information.

5) Personal Content Provision Scenario

A fifth scenario S115 is a personal content provision scenario. The display system can receive user personal data through the input device or the communication device. The display system can provide content corresponding to the user personal data.

6) Item Provision Scenario

A sixth scenario S116 is an item provision scenario. The cargo system can receive user data through the input device or the communication device. The user data may include user preference data, user destination data, etc. The cargo system 355 can provide items based on the user data.

7) Payment Scenario

A seventh scenario S117 is a payment scenario. The payment system can receive data for price calculation from at least one of the input device, the communication device and the cargo system. The payment system can calculate a price for use of the vehicle by the user based on the received data. The payment system can request payment of the calculated price from the user (e.g., a mobile terminal of the user).

8) Display System Control Scenario of User

An eighth scenario S118 is a display system control scenario of a user. The input device can receive a user input having at least one form and convert the user input into an electrical signal. The display system can control displayed content based on the electrical signal.

9) AI Agent Scenario

A ninth scenario S119 is a multi-channel artificial intelligence (AI) agent scenario for a plurality of users. The AI agent can discriminate user inputs from a plurality of users. The AI agent can control at least one of the display system, the cargo system, the seat system and the payment system based on electrical signals obtained by converting user inputs from a plurality of users.

10) Multimedia Content Provision Scenario for Multiple Users

A tenth scenario S120 is a multimedia content provision scenario for a plurality of users. The display system can provide content that can be viewed by all users together. In this case, the display system can individually provide the same sound to a plurality of users through speakers provided for respective seats. The display system can provide content that can be individually viewed by a plurality of users. In this case, the display system can provide individual sound through a speaker provided for each seat.

11) User Safety Secure Scenario

An eleventh scenario S121 is a user safety secure scenario. When information on an object around the AI mobility device which threatens a user is acquired, the main controller can control an alarm with respect to the object around the AI mobility device to be output through the display system.

12) Personal Belongings Loss Prevention Scenario

A twelfth scenario S122 is a user's belongings loss prevention scenario. The main controller can acquire data about user's belongings through the input device. The main controller can acquire user motion data through the input device. The main controller can determine whether the user exits the AI mobility device leaving the belongings in the AI mobility device based on the data about the belongings and the motion data. The main controller can control an alarm with respect to the belongings to be output through the display system.

13) Alighting Report Scenario

A thirteenth scenario S123 is an alighting report scenario. The main controller can receive alighting data of a user through the input device. After the user exits the AI mobility device, the main controller can provide report data according to alighting to a mobile terminal of the user through the communication device. The report data can include data about a total charge for using the AI mobility device 10.

AI Mobility Device-to-Everything (V2X)

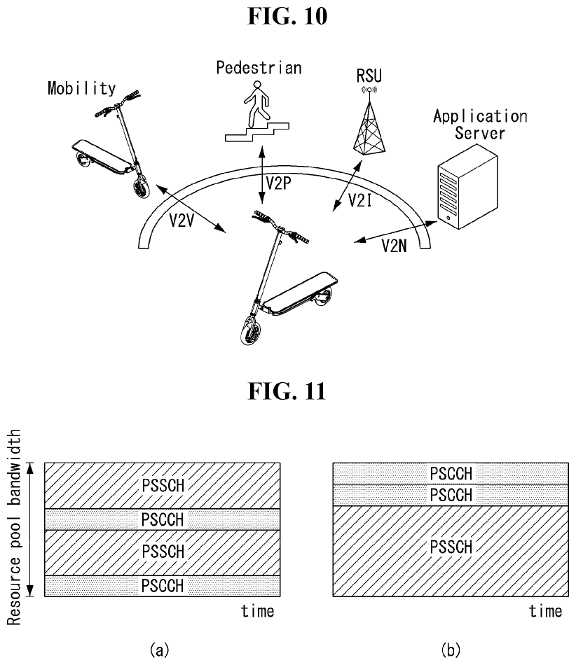

FIG. 10 is an example of V2X communication to which the present disclosure is applicable.

The AI mobility device may be referred to as a vehicle.

The V2X communication includes communication between a vehicle and all objects (e.g., Vehicle-to-Everything), such as Vehicle-to-Vehicle (V2V) referring to communication between vehicles, Vehicle-to-Infrastructure (V2I) referring to communication between a vehicle and an eNB or a Road Side Unit (RSU), and Vehicle-to-Pedestrian (V2P) or a Vehicle-to-Network (V2N) referring to communication between a vehicle and a UE with an individual (pedestrian, bicycler, vehicle driver, or passenger).

The V2X communication may indicate the same meaning as V2X side-link or NR V2X, or may include a broader meaning including the V2X side-link or NR V2X.

For example, the V2X communication can be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication can be provided via a PC5 interface and/or a Uu interface. In this case, in a wireless communication system that supports the V2X communication, there may exist a specific network entity for supporting the communication between the vehicle and all the objects. For example, the network object may be a BS (eNB), the road side unit (RSU), a UE, an application server (for example, a traffic safety server), or the like.

In addition, the UE executing V2X communication includes not only a general handheld UE but also a vehicle UE (V-UE), a pedestrian UE, a BS type (eNB type) RSU, a UE type RSU, a robot having a communication module, or the like.

The V2X communication may be executed directly between UEs or may be executed through the network object(s). V2X operation modes can be divided according to a method of executing the V2X communication.

The V2X communication requires a support for UE pseudonymity and privacy when a V2X application is used so that an operator or a third party cannot track a UE identifier within a V2X support area.

Terms frequently used in the V2X communication are defined as follows.
Road Side Unit (RSU): The RSU is a V2X serviceable device that can perform transmission/reception with a moving vehicle using a V2I service. Furthermore, the RSU can exchange messages with other entities supporting the V2X application as a fixed infrastructure entity supporting the V2X application. The RSU is a term often used in the existing ITS specifications, and a reason for introducing this term in 3GPP specifications is to make it easy to read a document in an ITS industry. The RSU is a logical entity that combines a V2X application logic with functions of a BS (referred to as BS-type RSU) or a UE (referred to as UE-type RSU).
V2I service: A type of V2X service in which one is a vehicle and the other is an entity belongs to an infrastructure.
V2P service: A type of the V2X service in which one is a vehicle and the other is a device (for example, handheld UE carried by pedestrian, bicycler, driver, or passenger) carried by an individual.
V2X service: A 3GPP communication service type in which a transmitting or receiving device is related to a vehicle.
V2X enabled UE: A UE supporting the V2X service.
V2V service: A type of the V2X service in which both in the communication are vehicles.
V2V communication range: A range of direct communication between two vehicles participating in the V2V service.

As described above, the V2X application referred to as the V2X (Vehicle-to-Everything) includes four types such as (1) Vehicle-to-Vehicle (V2V), (2) Vehicle-to-infrastructure (V2I), (3) Vehicle-to-Network (V2N), and (4) Vehicle-to-Pedestrian (V2P).

FIG. 11 shows a resource allocation method in a side-link where the V2X is used.

In the side-link, different physical side-link control channels (PSCCHs) may be separately allocated in a frequency domain, and different physical side-link shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP release 14 and 15, supports for the V2V and V2X services are introduced in LTE.

Requirement for supports with respect to an enhanced V2X use case are broadly divided into four use case groups.

(1) A Vehicle Platooning can dynamically form a platoon in which vehicles move together. All vehicles in the platoon get information from the top vehicle to manage this platoon. These pieces of information allow the vehicles to be operated in harmony in the normal direction and to travel together in the same direction.

(2) Extended sensors can exchange raw data or processed data collected by a local sensor or a live video image in a vehicle, a road site unit, a pedestrian device, and a V2X application server. In the vehicle, it is possible to raise environmental awareness beyond what a sensor in the vehicle can sense, and to ascertain broadly and collectively a local situation. A high data transmission rate is one of main features.

(3) Advanced driving allows semi-automatic or full-automatic driving. Each vehicle and/or the RSU shares own recognition data obtained from the local sensor with a proximity vehicle and allows the vehicle to synchronize and coordinate a trajectory or maneuver. Each vehicle shares a driving intention with the proximity vehicle.

(4) Remote driving allows a remote driver or the V2X application to drive the remote vehicle for a passenger who cannot drive the remote vehicle in his own or in a dangerous environment. If variability is restrictive and a path can be forecasted as public transportation, it is possible to use Cloud computing based driving. High reliability and a short waiting time are important requirements.

Each UE has a Layer-2 identifier for V2 communication through one or more PC5s. The Layer-2 identifier includes a source Layer-2 ID and a destination Layer-2 ID.

The source and destination Layer-2 IDs are included in a Layer-2 frame, and the Layer-2 frame is transmitted through a layer-2 link of PC5 that identifies a source and a destination of Layer-2 on the frame.

Selection of the source and destination Layer-2 IDs of the UE is based on a communication mode of V2X communication of the PC5 of the layer-2 link. The source Layer-2 ID may be different between different communication modes.

When IP-based V2X communication is allowed, the UE is configured to use a link-local IPv6 address as a source IP address. The UE may use this IP address for V2X communication of the PC5 without having to send a Neighbor Solicitation and Neighbor Advertisement message for discovery of duplicate addresses.

If one UE has an active V2X application that requires personal information protection supported in a current geographic area, the source Layer-2 ID may change over time and may be randomized for a source UE (e.g., AI mobility) to be tracked or distinguished from other UEs only for a specific time. In the case of IP-based V2X communication, the source IP address also needs to change over time and needs to be randomized.

Changes of identifiers of the source UE needs to be synchronized in a layer used in the PC5. That is, if an application layer identifier is changed, the source Layer-2 ID and the source IP address are also required to be changed.

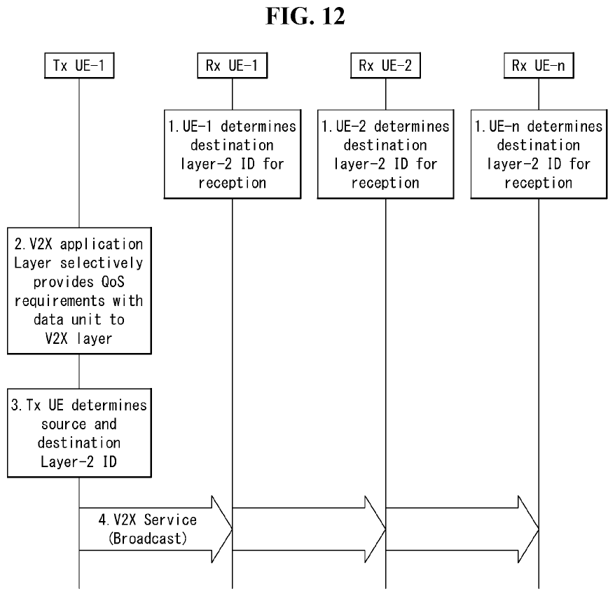

FIG. 12 is a diagram illustrating a procedure for a broadcast mode of V2X communication using PC5.

A receiving UE (Rx UE) determines a destination Layer-2 ID for broadcast reception. The destination Layer-2 ID is transferred to ab AS layer of the receiving UE for reception.

A V2X application layer of a transmitting UE (Tx UE) may provide a data unit and provide V2X application requirements.

The transmitting UE determines a destination Layer-2 ID for broadcasting. The transmitting UE allocates a source Layer-2 ID by itself.

A broadcast message transmitted by the transmitting UE transmits V2X service data using a source Layer-2 ID and a destination Layer-2 ID.

A typical form of a standard for encryption of messages transmitted and received in a communication environment of AI mobility is basic safety message (BSM) defined in ‘SAE J2735’. BSM refers to a broadcast message periodically received from the AI mobility and is designed to increase safety. AI mobilities transmit a message every 100 msec and a receiving AI mobility determines safety of AI mobility therethrough. The BSM is divided into transmitted information and additional information, which are defined as Part 1 and Part 2. The contents of such information may include a location of the AI mobility, a movement direction, a current time, and status information of the AI mobility.

A message ID of the AI mobility may be designated as msgID, msgCnt, id, and secMark, and 8 bytes may be allocated. A location value of the AI mobility may be designated as lat, long, elev, or accuracy, and 14 bytes may be allocated. ‘SAE J236’ may be referred to for detailed values of field values.

Table 1 shows an example of the BSM which may be applied in the present disclosure.

TABLE 1

| BSMcoreData ::= SEQUENCE { | |
|---|---|
| msgCnt | MsgCount, |
| id | TemporaryID, |
| secMark | DSecond, |
| lat | Latitude, |
| long | Longitude, |
| elev | Elevation, |
| accuracy | PositionalAccuracy, |
| transmission | TransmissionState, |
| speed | Speed, |
| heading | Heading, |
| angle | SteeringWheelAngle, |
| accelSet | AccelerationSet4Way, |
| brakes | BrakeSystemStatus, |
| size | VehicleSize |
| } | |

In the present disclosure, the BSM may be substituted with a V2X message or a V2X safety message which performs a similar operation.

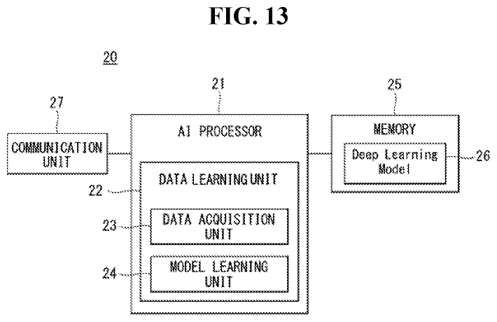

FIG. 13 is a block diagram of an artificial intelligence (AI) device according to an embodiment of the present disclosure.

An AI device 20 may include an electronic device including an AI module capable of performing AI processing or a server including an AI module. In addition, the AI device 20 may be included as a component of at least a part of the AI mobility 10 shown in FIG. 6 and may be provided to perform at least a part of AI processing together.

The AI processing may include all operations related to driving of the AI mobility 10 shown in FIG. 9. For example, AI mobility may perform processing on sensing data or driver data to perform processing/determination or a control signal generating operation. Also, for example, AI mobility may perform AI processing on data acquired through interaction with another electronic device provided in the AI mobility to perform driving control.

The AI apparatus 20 may include an AI processor 21, a memory 25 and/or a communication unit 27.

The AI apparatus 20 may be a computing apparatus which may perform a neural network learning and implemented with various electronic devices such as a server, a desktop, a PC, a notebook PC, a tablet PC.

The AI processor 21 may perform a neural network learning using the program stored in the memory 25. Particularly, the AI processor 21 may perform a neural network learning for recognizing vehicle related data. Here, the neural network for recognizing the vehicle related data may be designed to simulate a brain structure of a human on a computer and may include a plurality of network nodes having a priority which simulating a neuron of human neural network. A plurality of network nodes may exchange data according to each connection relation to simulate a synaptic activity of the neuron, which the neuron exchanges a signal through a synapse. Here, the neural network may include a deep learning model which is developed from the neural network model. In the deep learning model, a plurality of network nodes may exchange data according to a convolution connection relation with being located in different layers. An example of the neural network model may include various deep learning techniques such as deep neural networks (DNN), convolutional deep neural networks (CNN), Recurrent Boltzmann Machine (RNN), Restricted Boltzmann Machine (RBM), deep belief networks (DBN), Deep Q-Network, and may be applied to a field such as computer vision, voice recognition, natural language process and voice/signal processing.

The processer that performs the functions described above may be a general-purpose processor (e.g., CPU) but an AI-dedicated processor (e.g., GPU) for an artificial intelligence learning.

The memory 25 may store various types of program and data required for an operation of the AI apparatus 20. The memory 25 may be implemented with non-volatile memory, volatile memory, flash memory, hard disk drive (HDD) or solid-state drive (SDD). The memory 25 may be accessed by the AI processor 21 and read/record/modification/deletion/update of data may be performed by the AI processor 21. In addition, the memory 25 may store a neurotic network model (e.g., deep learning model 26) which is generated through a learning algorithm for data classification/recognition according to an embodiment of the present disclosure.

The AI processor 21 may include a data learning unit 22 that learns a neurotic network for the classification/recognition. The data learning unit 22 may learn a criterion on which learning data is used to determine the classification/recognition and how to classify and recognize data using the learning data. The data learning unit 22 may obtain learning data used for learning and apply the obtained learning data to the deep learning model, and accordingly, learn the deep learning model.

The data learning unit 22 may be manufactured in at least one hardware chip shape and mounted on the AI apparatus 20. For example, the data learning unit 22 may be manufactured in hardware chip shape dedicated for the artificial intelligence (AI) or manufactured as a part of a general-purpose processor (CPU) or a graphic processing processor (GPU) and mounted on the AI apparatus 20. Furthermore, the data learning unit 22 may be implemented with a software module. In the case that the data learning unit 22 is implemented with a software module (or program module including instruction), the software module may be stored in a non-transitory computer readable media. In this case, at least one software module may be provided by an Operating System (OS) or an application.

The data learning unit 22 may include a learning data acquisition unit 23 and a model learning unit 24.

The learning data acquisition unit 23 may acquire learning data which is required for the neurotic network model for classifying and recognizing data. For example, the learning data acquisition unit 23 may obtain vehicle data and/or sample data for being inputted in the neurotic network model as learning data.

The model learning unit 24 may learn to have a determination criterion how to classify predetermined data by the neurotic network model using the obtained learning data. In this case, the model learning unit 24 may learn the neurotic network model through a supervised learning that uses at least one determination criterion among learning data. Alternatively, the model learning unit 24 may learn the learning data without supervising and learn the neurotic network model through an unsupervised learning which discovers a determination criterion. In addition, the model learning unit 24 may learn the neurotic network model through a reinforcement learning using a feedback whether a result of an assessment of situation according to learning is correct. Furthermore, the model learning unit 24 may learn the neurotic network model using a learning algorithm including an error back-propagation or a gradient decent.

When the neurotic network model is learned, the model learning unit 24 may store the learned neurotic network model in a memory. The model learning unit 24 may store learned neurotic network model in the memory of a server connected to the AI apparatus 20 in wired or wireless manner.

The data learning unit 22 may further include a learning data pre-processing unit or a learning data selection unit for improving an analysis result of the learning model or saving a resource or time which is required for generating a recognition model.

The learning data pre-processing unit may pre-process obtained data such that the obtained data is used for learning for an assessment of situation. For example, the learning data pre-processing unit may process the obtained data in a preconfigured format such that the model learning unit 24 uses the learning data obtained for learning an image recognition.

In addition, the learning data selection unit may select the data required for learning between the learning data obtained in the learning data acquisition unit 23 or the learning data pre-processed in the pre-processing unit. The selected learning data may be provided to the model learning unit 24. For example, the learning data selection unit may detect a specific area in the image obtained through the camera and select only the data for the object included in the specific area as the learning data.

Furthermore, the data learning unit 22 may further include a model evaluation unit for improving the analysis result of the learning model.

The model evaluation unit may input evaluation data in the neurotic network model, and in the case that the analysis result fails to satisfy a predetermined level, make the data learning unit 22 learn the neurotic network model again. In this case, the evaluation data may be predefined data for evaluating a recognition model. As an example, in the case that the number of evaluation data or the ratio in which the analysis result is not clear exceeds a preconfigured threshold value in the analysis result of the recognition model which is learned for the evaluation data, the model evaluation unit may evaluate that the analysis result fails to satisfy the predetermined level.

The communication unit 27 may the AI processing result by the AI processor 21 to an external electronic device.

Here, the external electronic device may be defined as an automatic driving vehicle. In addition, the AI apparatus 20 may be defined as another vehicle or 5G network that communicates with the automatic driving vehicle or an automatic driving module mounted vehicle. The AI apparatus 20 may be implemented with being functionally embedded in the automatic driving module provided in a vehicle. In addition, 5G network may include a server or module that performs a control in relation to an automatic driving.

The AI apparatus 20 shown in FIG. 6 is described by functionally dividing into the AI processor 21, the memory 25 and the communication unit 27, but the elements described above may be integrated in a module and called an AI module.

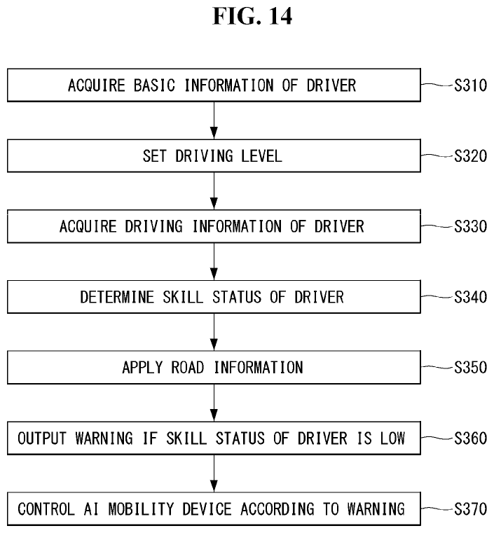

FIG. 14 is a flowchart of an AI mobility device control method according to an embodiment of the present disclosure.

Referring to FIG. 14, a method of controlling an AI mobility device according to an embodiment of the present disclosure may be realized in AI mobility including a function described above with reference to FIGS. 1 to 13 or an AI computing device for controlling the AI mobility. Specifically, the method of controlling an AI mobility device according to an embodiment of the present disclosure may be implemented in the AI mobility 10 described above with reference to FIGS. 5 to 8 and 13.

The processor (170 of FIG. 7) may acquire basic information of the driver.

The processor 170 may be provided with basic information of the driver through the driver's smart device or mobile terminal under the control of the transceiver. The driver may directly input the basic information of the driver through a user interface device (200 in FIG. 6) disposed in the AI mobility. The basic information of the driver (e.g., identification information, or personal information) can include gender, date of birth, AI mobility experience, driver's license, etc.

The processor 170 may set a driving level based on the basic information of the driver. The processor 170 may classify the driving level into a plurality of levels. For example, the plurality of levels may be classified into a first level to a tenth level. First level to third level may be elementary levels, fourth level to seventh level may be intermediate level, and eighth level to tenth level may be advanced levels. For example, the plurality of levels may be classified into a beginner's level, an intermediate level, and an advanced level.

The processor 170 may set a driving mode of the AI mobility to correspond to a set driving level. For example, when the set driving level is the first level to the third level, the processor 170 may set the AI mobility to the driving mode for beginners to correspond to the level. When the set driving level is the fourth level to the seventh level, the processor 170 may set the AI mobility to the driving mode for intermediates to correspond to the level. When the set driving step is the eighth level to the tenth level, the processor 170 may set the AI mobility to the driving mode for advanced drivers to correspond to the level.

The processor 170 may acquire driving information of the driver based on the driving level and while the driver is driving. The processor 170 may collect driving information by sensing the AI mobility being driven and the driver driving or controlling the AI mobility based on the set driving level. The processor 170 may store collected or acquired driving information in a memory. The processor 170 may store driving information in the memory until the driver turns off an engine of the AI mobility after turning it on. For example, the sensor may sense a driving style of the driver, a driving habit of the driver, and a driving posture of the driver under the control of the processor 170. The processor 170 may extract driving information on the driver from the sensed driving style of the driver, driving habit of the driver, and driving posture of the driver. For example, the driving information may include quick start, sudden stop, speed violation, signal violation, lane change, and the like.

The processor 170 may determine as skill status of the driver based on the driving information of the driver. The processor 170 may extract at least one driving information from the sensed driving style of the driver, a driving habit of the driver, and a driving posture of the driver, and analyze the extracted driving information to measure a driving skill level of the driver and determine a skill status of the driver based on the measured driving skill level.

The processor 170 may set a reference range of the driving skill level to be different according to a driving mode. The processor 170 may set a reference range of driving skill level corresponding to the driving mode for beginners to be wider than a reference range of driving skill level corresponding to the driving mode for advanced drivers.

The processor 170 may apply road information corresponding to the skill status of the driver. The processor 170 may receive road information related to a road from at least one sensor and an external device.

The processor 170 may apply road information provided based on the determined skill status of the driver. For example, if the determined skill status of the driver is determined as a beginner, the processor 170 may preferentially apply an uncomplicated and comfortable route in the road information, a route that is less crowded due to a small floating population, and a large road rather than a narrow road. If it is determined that the determined skill status of the driver is an advanced driver, the processor 170 may preferentially apply a fast route or a shortest route even if it is complex.

When it is determined that the skill status of the driver is lower than a predetermined reference based on road information, the processor 170 may output a warning signal and control AI mobility according to the warning signal. For example, in case of driving based on road information applied as a driving mode for an advanced driver, the processor 170 may set a reference range for a driving skill level to 80 based on the advanced driver. When the measured driving skill level of the driver is measured as 75, the processor 170 may determine that the skill status of the driver is lower than that of the advanced driver based thereon.

In addition, in case of driving based on road information applied as the driving mode for beginners, the processor 170 may set the reference range for the driving skill level to 40 based on the beginner. If the measured driving skill level of the driver level is measured as 46, the processor 170 may determine that the skill status of the driver is higher than that of the beginner. The processor 170 may determine the skill status of the driver to be different according to a preset reference range of the driving skill level, even if substantially the same driving skill level is acquired.

When the skill status of the driver is lower than the reference range of the driving skill level, the processor 170 may output a warning signal and control the AI mobility. The processor 170 may differently control the AI mobility based on the skill status of the driver.

The processor 170 may determine that the driving skill of the driver is good if the skill status of the driver is high based on the reference range of the driving skill level. Accordingly, the processor 170 may support to control the driver to drive by himself, while reducing the control of the AI mobility to the minimum.

Alternatively, the processor 170 may determine that the driving skill of the driver is insufficient if the skill status of the driver is low based on the reference range of the driving skill level. Accordingly, the processor 170 may control to guide to a more stable and convenient route using road information or sensing information collected in real time, while increasing the control of AI mobility to the maximum.

In addition, if the processor 170 determines that the driving skill level is significantly lower than the reference range of the driving skill level, the processor 170 may switch the AI mobility driven in the manual driving mode to an AI driving mode, moves to a safe area, and deprive or stop a driving control of the driver or reset the driving mode appropriate for the driving skill level of the driver.

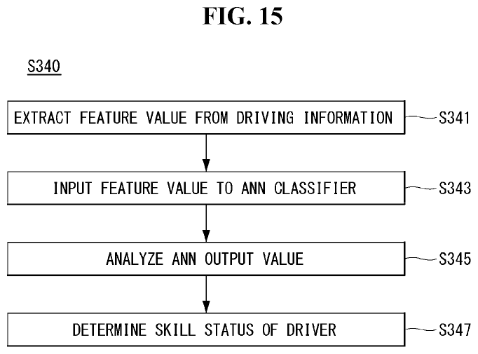

FIG. 15 is a view illustrating an example of determining a skill status of a driver according to an embodiment of the present disclosure.

Referring to FIG. 15, the processor 170 may extract feature values from driving information acquired through at least one sensor in order to determine a skill status of the driver (S341).

For example, the processor 170 may receive driving information on a driving posture of the driver, a driving style of the driver, and a driving habit of the driver from at least one sensor (e.g., an acceleration sensor and a vibration sensor). The processor 170 may extract a feature value from the driving information. The feature value specifically indicates quick start, sudden stop, speed violation, signal violation, lane change, acceleration, sudden deceleration, vibration intensity, the number of vibrations, and the like among at least one characteristic that may be extracted from the driving information.

The processor 170 may control the feature values to be input to an artificial neural network (ANN) classifier trained to determine or distinguish a skill status of the driver (S343).

The processor 170 may generate a driving skill detection input by combining the extracted feature value. The driving skill detection input may be input to the ANN classifier traded to distinguish the skill status of the driver based on the extracted feature values.

The processor 170 may analyze an output value of the ANN (S345) and determine a skill status of the driver based on the ANN output value (S347).

The processor 170 may identify the driving skill status of the driver from the output of the ANN classifier.

Meanwhile, in FIG. 14, an example in which an operation of identifying a skill status of the driver through AI processing is implemented in AI mobility processing is illustrated but the present disclosure is not limited thereto. For example, AI processing may be done on a 5G network based on driving information received from AI mobility.

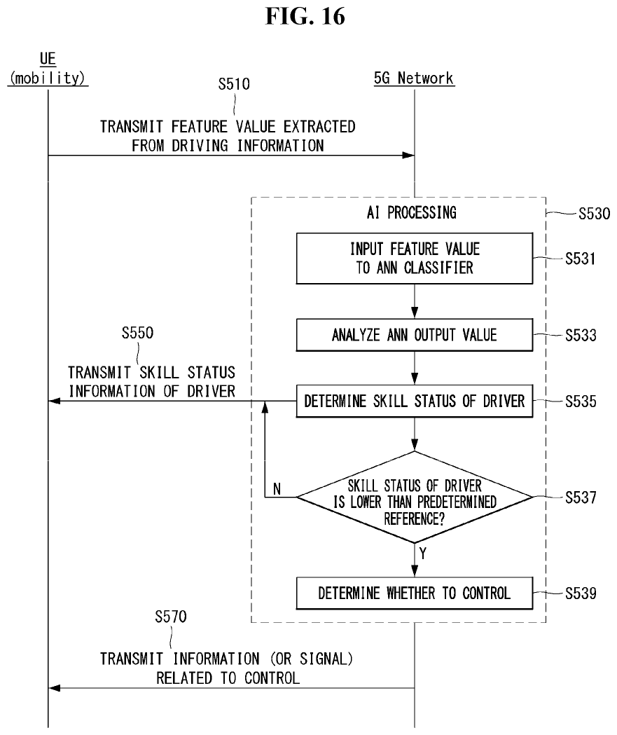

FIG. 16 is a diagram illustrating another example of determining a skill status of a driver according to an embodiment of the present disclosure.

The processor 170 may control a transceiver or a communication unit to transmit driving information of a driver to an AI processor included in a 5G network. In addition, the processor 170 may control the communication unit or the transceiver to receive AI-processed information from the AI processor.

The AI-processed information may be information that determines a skill status of the driver.

Meanwhile, AI Mobility may perform an initial access procedure with the 5G network in order to transmit the driving information of the driver over the 5G network. The AI mobility 10 may perform an initial access procedure with the 5G network based on a synchronization signal block (SSB).

In addition, the AI mobility 10 may receive downlink control information (DCI) used to schedule transmission of driving information of the driver acquired from at least one sensor provided in the AI mobility through a wireless communication unit from the network.

The processor 170 may transmit the driving information of the driver to a network based on the DCI.

The driving information of the driver is transmitted to the network through a PUSCH, and the SSB and a DM-RS of the PUSCH may be quasi-co-located (QCL-ed) for a QCL type D.

Referring to FIG. 16, the AI mobility 10 may transmit the feature value extracted from the driving information to the 5G network (S510).

Here, the 5G network may include an AI processor or an AI system, and the AI system of the 5G network may perform AI processing based on the received driving information (S530).

The AI system may input feature values received from the AI mobility 10 into the ANN classifier (S531). The AI system may analyze the ANN output value (S533) and determine a skill status of the driver from the ANN output value (S535). The 5G network may transmit the skill status information of the driver determined by the AI system to the AI mobility 10 through a wireless communication unit (S550).

Here, the skill status information of the driver may include information on the driving posture of the driver, a driving style of the driver, a driving habit of the driver, and the like, and quick start, sudden stop, speed violation, signal violation, lane change, and the like.

When it is determined that the skill status of the driver is lower than a predetermined reference based on the acquired road information (S537), the AI system may output a warning signal and control the AI mobility according to the warning signal. For example, the AI system may determine that a driving skill of the driver is insufficient if the skill status of the driver is low based on the reference range of the driving skill level. Accordingly, the AI system may control to guide to a more stable and convenient route using road information or sensing information collected in real time, while increasing the control of AI mobility to the maximum.

When it is determined that the driving skill level of the driver is insufficient, the AI system may determine whether to control it (S539). In addition, the AI system may transmit control-related information (or signal) to the AI mobility 10 (S570). For example, if it is determined that the skill status of the driver is significantly lower than the reference range of the driving skill level, the AI system may switch the AI mobility 10 driven in the manual driving mode to an AI driving mode and move to a safe area, and deprive or stop a driving control right of the driver or reset it to a driving mode corresponding to the driving skill of the driver.

Meanwhile, the AI mobility 10 may transmit only driving information to the 5G network and extract a feature value corresponding to a driving skill detection input to be used as an input of the ANN for determining a skill status of the driver from the driving information in the AI system included in the 5G network.

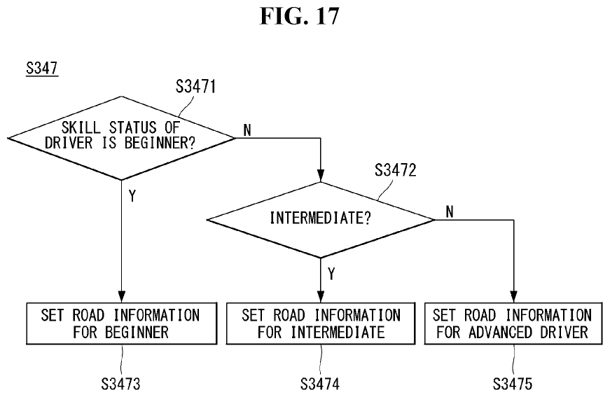

FIG. 17 is a view illustrating a specific example of setting road information in response to a skill status of the driver according to an embodiment of the present disclosure.

Referring to FIG. 17, the processor 170 may apply road information provided based on a determined skill status of the driver (S347).

When it is determined that the determined skill status of the driver is a beginner (S3471), the processor 170 may set road information for beginners (S3473). For example, the road information for beginners may include an uncomplicated and convenient route, a route that is less crowded due to a small floating population, and a larger road than a narrow road in the road information.

When it is determined that the determined skill status of the driver is an intermediate rather than a beginner (S3472), the processor 170 may set road information for intermediates (S3474). For example, the road information for intermediates may include a route which is moderately comfortable and a route with an appropriate floating population in the road information.

If it is determined that the determined skill status of the driver is an advanced driver (S3472), the processor 170 may set road information for the advanced driver (S3475). For example, the road information for advanced drivers may include a fast route or a shortest route even if it is complex.

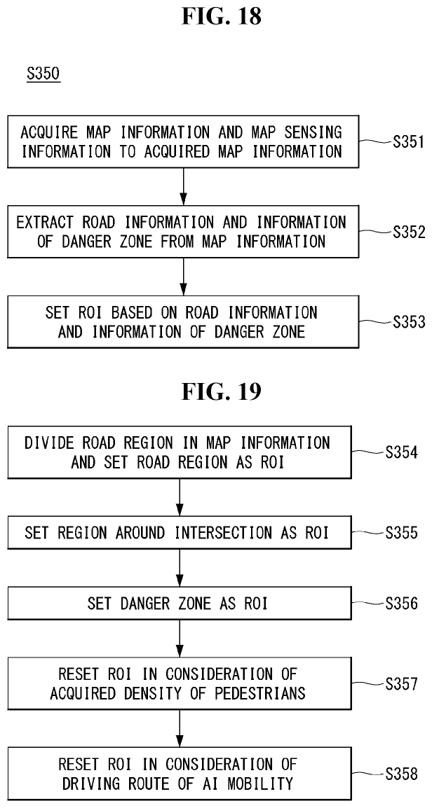

FIG. 18 is an embodiment to which the present disclosure may be applied.

Referring to FIG. 18, the processor 170 may acquire map information and map sensing information acquired through a sensor of the AI mobility 10 to the acquired map information (S351). The map information may be HD MAP data, and the processor 170 may acquire a 3D space by mapping the sensing information acquired through a LiDAR and determine a location on the map of the AI mobility 10.

The processor 170 may extract road information and information on a danger zone from the map information (S352). The danger zone refers to an area with many dangerous factors and may include areas with children's protection zones, crosswalks, construction zones, intersections, or entrance and exit of parking lots. The information on the danger zone includes a geographical range and location information of the danger zone.

The processor 170 may configure a region of interest (ROI) based on the extracted road information and the danger zone information (S353). Specifically, the processor 170 may set the ROI based on a road to be driving or to be driven in consideration of the current location and a driving direction of the AI mobility 10.

FIG. 19 is an embodiment of a method of setting an ROI to which the present disclosure may be applied.

The processor 170 may divide a road region in the received map information and set the road region as an ROI (S354). The processor 170 may receive HD MAP data and map the POINT CLOUD to the received HD MAP data. POINT CLOUD is a 3D shape or a set of points that represent a shape. Each point may contain a unique set of X, Y, and Z coordinates. The processor 170 may generate a POINT CLOUD through a LiDAR sensor. The processor 170 may map the previously collected POINT CLOUD to HD MAP data. The processor 170 may divide a road region from HD MAP data to which POINT CLOUD is mapped. In order to divide the road region, the processor 170 may use planar segmentation, ray ground filter, and DNN. In addition, the processor 170 may use a vertical vector component of a road vector included in the HD MAP.

The processor 170 may set a region around an intersection to an ROI (S355). The processor 170 may determine a location of the intersection using road information included in the map information and set a certain area including the intersection in the road region as an ROI.

The processor 170 may set a danger zone as an ROI (S356). The map information may include location information on the danger zone. Accordingly, the processor 170 may acquire an accurate location of the danger zone through mapping of the LiDAR point cloud and HD MAP data. The processor 170 may set the danger zone as an ROI, while expanding and setting a geographic range of the ROI indicating the danger zone. Accordingly, the geographic range of the ROI set for each danger zone and the predetermined region including the aforementioned intersection may be different.

The processor 170 may set a geographic range based on the LiDAR point of the danger zone. Alternatively, it is possible to consider a driving state of the AI mobility 10 driving in a danger zone, traffic light signal information, and the like. For example, if a distance value of points farthest from a LiDAR point indicating a point where the crosswalk meets a sidewalk or a LiDAR point indicating the edge of a construction site is set to R and a speed of the AI mobility 10 that drives, a remaining time of a pedestrian crossing signal obtained through a V2X message, and the like is set as a weight value, a radius of the ROI may be determined through Equation 1 below.

Radius=R*Weight_velocity*Weight_remain_time [Equation 1]

The processor 170 may reset the ROI in consideration of the acquired density of pedestrians through the sensing information (S357). Specifically, the processor 170 may determine a density of pedestrian in the ROI through the sensing information. For example, a pedestrian waiting to walk on the crosswalk may be detected by expanding and setting a geographic range of the ROI for crosswalks on the sidewalk connected to the crosswalk by the processor 170. The detected density of pedestrians may be calculated using the number of objects detected by the processor 170 based on a certain geographic range of a ROI including the sidewalk connected to the crosswalk.

The processor 170 may enlarge the geographic range of the ROI to the sidewalk connected to the crosswalk and set. In addition, the processor 170 may reset the ROI set to the sidewalk connected to the crosswalk in consideration of the acquired density of pedestrians through the sensing information. For example, if a pedestrian density of a second ROI is greater than a pedestrian density of a first ROI, the processor 170 may reset the second ROI such that the geographic range of the second ROI is larger than the geographical range of the first ROI.

The processor 170 may reset the ROI in consideration of a driving path of the AI mobility 10 (S358). The processor 170 may determine a current location using the GPS of the AI mobility 10 or the like, and receive or calculate destination information and a driving route of the AI mobility 10. Accordingly, the processor 170 may release the ROI set in a region not located on the driving route of the AI mobility 10 or a road (including sidewalk). Through this, the processor 170 may limit the ROI, thereby reducing the region to be detected by the AI mobility 10.

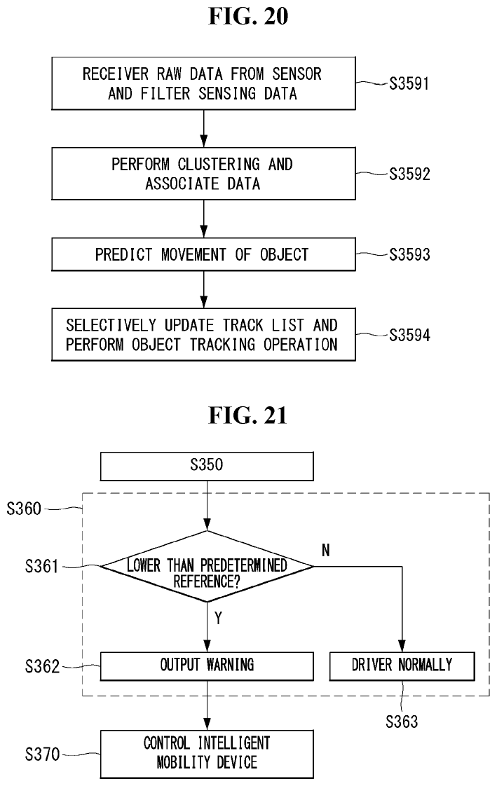

FIG. 20 is an example of an object tracking algorithm to which the present disclosure may be applied.

Object tracking is an operation of receiving information from sensors such as LiDAR, camera, or the like to acquire a location, speed, and type of an object (e.g., counterpart AI mobility, pedestrian, obstacle). Data processing of object tracking may be classified into sensing data filtering and tracking. Tracking may include clustering, data association, object motion prediction, selective track list updating, and object tracking operation. Here, the object tracking operation may include merge, classification of the tracked object, and start of object tracking.

The processor 170 receives raw data from a sensor and filters sensing data (S3591). Sensing data filtering is a process of processing raw data of the sensor before tracking is executed. Sensing data filtering refers to an operation of setting an ROI to reduce the number of sensing points and classifying only object points necessary for tracking through ground removal.

The processor 170 may cluster the filtered sensing data and perform an associating operation (S3592). For example, multiple points may be created on one object using LiDAR. The processor 170 may generate a single point by clustering several points generated in a single object through clustering. In addition, in order for the processor 170 to track an object, an operation of associating data of points created through clustering and points being tracked is required. For example, the processor 170 traverses the previously tracked objects, selects a point of a clustered object closest to the points of the previously tracked objects from among the points of the clustered object through the current sensor, and associates the both data. In order to increase accuracy of the object tracking algorithm in this data associating operation, even if selected as the point of the clustered object being closest, the processor 170 may remove the clustered object if a movement of the clustered object is uncertain or cannot be predicted. To this end, the trained AI processor 21 may be used.

The processor 170 may predict a movement of the object (S3593). Specifically, the processor 170 may predict the locations of the objects to be tracked through values related to the measured movement of the object in steps S3591 and S3592. To this end, the trained AI processor 21 may be used. If there is no value related to the measured movement of the object, a predicted movement of the object may be a value related to the measured movement of the object. In contrast, if there is a value related to the measured movement of the object, the value related to the motion of the object may be updated through a step of predicting movement of the object.

The processor 170 may selectively update the track list and perform an object tracking operation (S3594). When there is a value related to the measured movement of the object as described above, the processor 170 may update a track list managed for each object. To this end, a Kalman filter may be used. In addition, in order to perform an object tracking operation, the processor 170 may perform a process of merging objects to moving at a similar speed at a certain distance with the tracked object and a tracking object classification operation if points of sensing data matched to the tracked object are lower than a threshold, and then start object tracking. However, even in this case, in order to determine whether a pointer of the sensing data is a ghost, object tracking may be started after the pointer of the sensing data that is not associated with the data is verified.

In the present disclosure, the object tracking algorithm is not limited to an operation, and an object tracking algorithm for a similar purpose may be included in this disclosure.

FIG. 21 illustrates a method of controlling according to a skill status of a driver applicable to the present disclosure.

Referring to FIG. 21, the processor 170 may apply road information provided based on a determined skill status of a driver (S350). Details thereof have been described above with reference to FIG. 17 and thus will be omitted.

The processor 170 may determine the skill status of the driving driver based on the road information based on a preset reference (S360).

When it is determined that the skill status of the driving driver is higher than a predetermined reference based on the road information (S361), the processor 170 may control to drive normally (S363).

When it is determined that the skill status of the driving driver is lower than the predetermined reference based on the road information (S361), the processor 170 may output a warning signal (S362).

For example, the processor may output a warning signal when it is determined that the skill status of the driver is lower than that of a beginner based on road information for beginners. The processor may output a warning signal when it is determined that the skill status of the driver is lower than that of an intermediate based on the road information for the intermediate. The processor may output a warning signal when it is determined that the skill status of the driver is lower than that of an advanced driver based on the road information for advanced driver.

Thereafter, the processor 170 may control the AI mobility according to the warning signal (S370). Details thereof has been sufficiently described above and thus will be omitted here.

As described above, the AI mobility of the present disclosure may recognize and learn a driving pattern using an acceleration sensor and a vibration sensor during driving after recognizing a registered driver, and transmit a warning alarm when determining dangerous driving. For example, AI mobility may acquire learning data according to skill levels of beginner/intermediate/advanced by learning driving patterns using the acceleration sensor and the vibration sensor while driving by receiving driving experience from the driver. The AI mobility may determine a skill level by analyzing driving patterns when a new driver drives based on the learned data. The AI mobility may transmit a warning message such as deceleration if it is determined that it is dangerous to drive compared to the skill level.

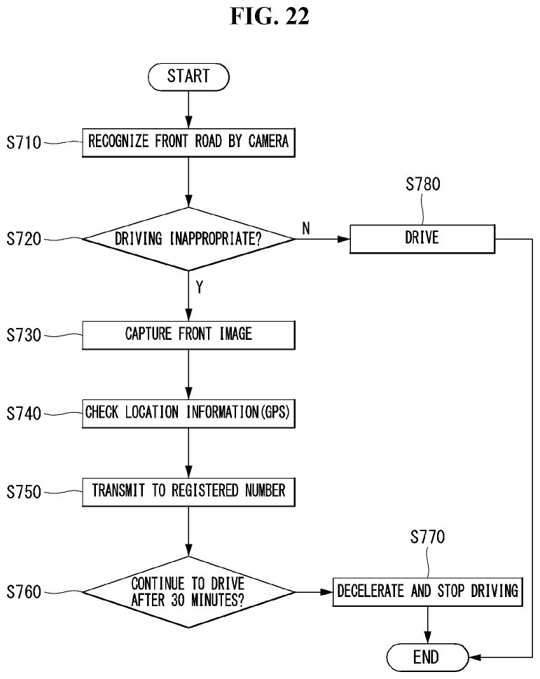

FIG. 22 illustrates an example of a method of controlling an AI mobility that may be applied to the present disclosure.

Referring to FIG. 22, a driver who intends to operate the AI mobility may provide basic information of the driver to the AI mobility.

The driver may input or register the basic information of the driver through an interface device disposed in a smart device, a mobile terminal, or the AI mobility.

The AI mobility may set a driving level based on the basic information of the driver. The AI mobility may drive on the road based on the driving level set under the driver's driving or control.

The AI mobility may image a driving road using a camera installed at the front and recognize a captured image (S710).

The AI mobility may image and recognize roads in real time and learn them. The AI mobility may determine whether or not the road driving is inappropriate based on the driving information of the driver and the recognized road information (S720). Details thereof has been sufficiently described with reference to FIGS. 1 to 21 and thus will be omitted here.

When it is determined that driving on the road is appropriate or normal (S720), the AI mobility may continue driving on the road (S780).

When it is determined that the driving of the road is inappropriate or abnormal (S720), the AI mobility may image the front and surroundings of the driving road using the camera (S730). For example, the AI mobility may determine that road driving is inappropriate in an area where electric kickboard or skateboard driving such as sidewalks is prohibited in the captured image.

If the AI mobility determines that driving on the road is inappropriate, it may check location information (S740) and transmit the captured image and/or a notification text to a previously registered number (S750). The previously registered number may be a guardian of the driver or a person related to the driver.

When driving is inappropriate through image recognition, the AI mobility may stop or slow down road driving after a certain period of time (S760). If driving is inappropriate through image recognition, the AI mobility may first operate a warning alarm before sending a notification text including the captured image to the input guardian's smart device, mobile terminal, or mobile phone.

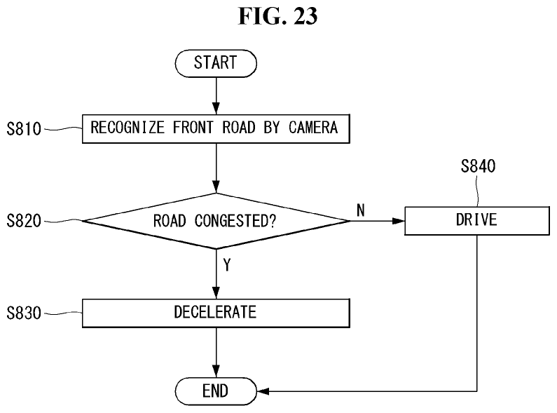

FIG. 23 illustrates another example of a method of controlling an AI mobility that may be applied to the present disclosure.

Referring to FIG. 23, the driver who intends to operate the AI mobility may provide basic driver information to the AI mobility.

The driver may input or register the basic information of the driver through an interface device disposed in a smart device, a mobile terminal, or an AI mobility.

The AI mobility may set a driving level based on the basic information of the driver. The AI mobility may drive on the road based on the driving level set under the driver's driving or control.

The AI mobility may image a driving road using the camera installed at the front and recognize the captured image (S810).

The AI mobility may determine a road condition through the captured image. The AI mobility may acquire information provided from the captured image, driving information of the driver, and a road condition provided from the outside, and determine whether the road is congested based thereon (S820).

When the AI mobility determines that the road is not congested (S820), it may continue to drive on the road (S840). The AI mobility may drive on the road while maintaining a driving speed.

When it is determined that the road is congested (S820), the AI mobility may control the driving speed to decelerate (S830). The AI mobility may control to gradually decelerate the driving speed based on a density of the floating population moving on the road.

For example, if the density of the floating population exceeds a preset range, the AI mobility may control to gradually decelerate the driving speed or check a flow of the floating population and control to stop for a certain period of time. If the density of the floating population exceeds the preset range, the AI mobility may reset the existing route and lead to another route.

In addition, when it is determined that the road is congested, the AI mobility may control to warn in advance before re-entering the corresponding road henceforth after updating a road condition DB.

As described above, the AI mobility may recognize road conditions or the degree of congestion of vehicles and crowding of people through image recognition and limit to an appropriate safe speed. For example, the AI mobility may limit a maximum speed during times when the road is congested while driving, such as commute time or the like and reduce the maximum speed during a time with less traffic.

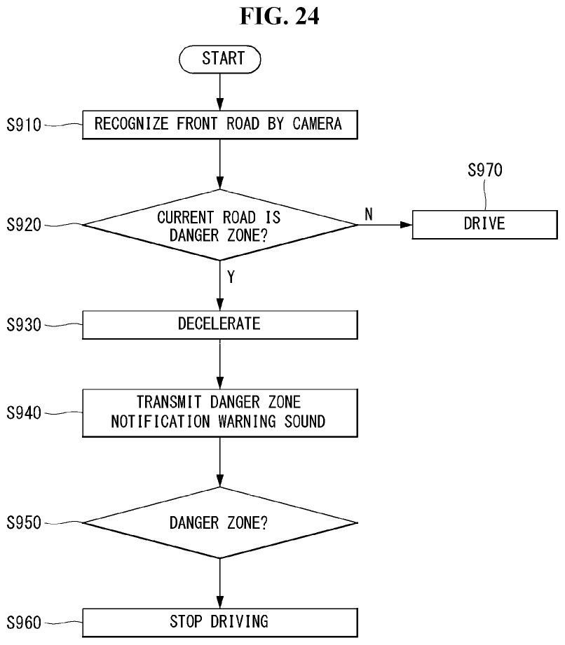

FIG. 24 illustrates an example of a method of controlling an AI mobility that may be applied to the present disclosure.

Referring to FIG. 24, a driver who intends to operate the AI mobility may provide basic information of the driver to the AI mobility.

The driver may input or register the basic information of the driver through an interface device disposed in a smart device, a mobile terminal, or the AI mobility.

The AI mobility may set a driving level based on the basic information of the driver. The AI mobility may drive on the road based on the driving level set under the driver's driving or control.

The AI mobility may image a driving road using the camera installed at the front and recognize a captured image (S910).

The AI mobility may determine whether the current road is a danger zone based on the captured image (S920). Since setting a danger zone or an ROI has been sufficiently described above with reference to FIGS. 18 to 20, and thus will be omitted here.

When it is determined that the current road is not a danger zone (S920), the AI mobility may continue to drive on the current road (S970). The AI mobility may drive on the road while maintaining a driving speed.

When it is determined that the current road is a danger zone (S920), the AI mobility may control the driving speed to decelerate (S930). The AI mobility may control to gradually decelerate to a minimum driving speed. Also, when it is determined that the current road is a danger zone (S920), the AI mobility may update information on the danger zone.

If an object/person is recognized within a distance determined as a danger zone, the AI mobility may stop the operation and sound a warning alarm (S940).

In addition, the AI mobility may determine whether the current road is a danger zone after a certain period of time has elapsed (S950). For example, the certain period of time may be rechecked every minute after the initial danger zone is detected.

When the AI mobility determines that the current road is not a danger zone after the certain period of time has elapsed (S950), the AI mobility may release the reduced driving speed and drive on the road normally (S970).

When it is determined that the current road is a danger zone after the certain period of time has elapsed (S950), the AI mobility may stop the operation (S960). In addition, if it is determined that the current road is a danger zone even after the certain period of time has elapsed (S950), the AI mobility may update information on the danger zone.

As described above, the AI mobility of the present disclosure may control to send a notification text along with a location to the guardian in case of an accident while driving. The AI mobility may accurately detect a location of an accident through a GPS sensor and may accurately recognize whether an accident has occurred by sensing a collision of a person/object/floor.

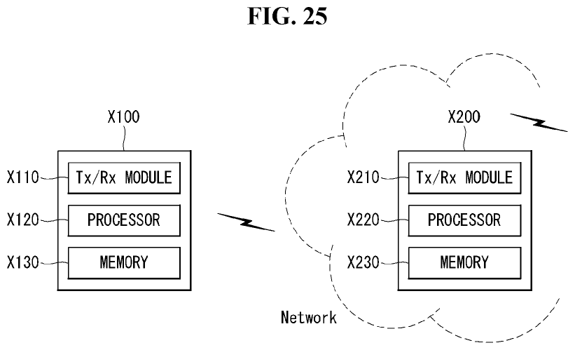

FIG. 25 is a general example of a device to which the present disclosure may be applied.

Referring to FIG. 19, the server X200 according to the proposed embodiment may include a communication module X210, a processor X220, and a memory X230. The communication module X210 may also be referred to as a radio frequency (RF) unit. The communication module X210 may be configured to transmit various signals, data and information to an external device and to receive various signals, data and information from an external device. The server X200 may be coupled to an external device by wire and/or wirelessly. The communication module X210 may be implemented by being separated into a transmitter and a receiver. The processor X220 may control the overall operation of the server X200, and may be configured for the server X200 to perform a function of computing and processing information to be transmitted/received with an external device. In addition, the processor X220 may be configured to perform a server operation proposed in the present disclosure. The processor X220 may control the communication module X110 to transmit data or a message to the UE, another vehicle, or another server according to the proposal of the present disclosure. The memory X230 may store the processed information and the like for a predetermined time and may be replaced with a component such as a buffer.

In addition, the specific configuration of the terminal device (X100) and the server (X200) as described above, may be implemented so that the above-described items described in various embodiments of the present disclosure may be applied independently or two or more embodiments are applied at the same time, and the contents of being duplicated is omitted for clarity.

The present disclosure described above can be embodied as computer-readable codes on a medium in which a program is recorded. The computer-readable medium includes all kinds of recording devices in which data that can be read by a computer system is stored. Examples of computer-readable media include hard disk drives (HDDs), solid state disks (SSDs), silicon disk drives (SDDs), ROMs, RAMs, CD-ROMs, magnetic tapes, floppy disks, optical data storage devices, and the like, and this also includes implementations in the form of carrier waves (e.g., transmission over the Internet). Accordingly, the above detailed description should not be construed as limiting in all aspects and should be considered as illustrative. The scope of the disclosure should be determined by reasonable interpretation of the appended claims, and all changes within the equivalent scope of the disclosure are included in the scope of the disclosure.

In addition, the above description has been made based on the service and the embodiments, which are merely examples and are not intended to limit the present disclosure, and it will be appreciated that various modifications and applications not illustrated above are possible without departing from the scope of the disclosure. For example, each component specifically shown in the embodiments may be modified to be implemented. Further, differences relating to such modifications and applications will have to be construed as being included in the scope of the disclosure defined in the appended claims.

The present disclosure has been described with reference to an example applied to a UE based on a 5G system, but can additionally be applied to various wireless communication systems and autonomous driving apparatuses.

According to an embodiment of the present disclosure, user stability may be improved by learning various data imaged while driving and guiding stable driving.

In addition, according to an embodiment of the present disclosure, since the skill level of the user is learned while driving and a driving pattern of the user is provided to correspond to the learned skill level, a more comfortable and stable driving may be guided, thereby further improving user stability.

In addition, according to the embodiment of the present disclosure, since the skill level of the user is learned while driving and a driving pattern of the user is provided to correspond to the learned skill level, convenience of mobility, convenience of transfer through optimized journey establishment, and optimal means of transportation may be used to improve user convenience, such as reducing a travel time.

In addition, according to the embodiment of the present disclosure, when the use of the AI mobility device increases according to stable driving, it is possible to reduce a cost ratio of an own vehicle, thereby improving traffic flow and significantly reducing smoke and energy.

The effects which may be obtained by the present invention are not limited to the aforementioned effects, and other technical effects not described above may be evidently understood by a person having ordinary skill in the art to which the present invention pertains from the following description

What is claimed is:

1. A method of controlling an artificial intelligence (AI) mobility device, the method comprising:
acquiring personal information of a driver and setting a driving level based on the personal information of the driver;
acquiring driving information of the driver based on the driving level while the driver is driving;
determining a skill status of the driver based on the driving information of the driver;
applying road information corresponding to the skill status of the driver; and
in response to determining that the skill status of the driver is lower than a predetermined reference based on the road information, outputting a warning and executing a function of the AI mobility device based on the warning.

2. The method of claim 1, wherein the driving information of the driver is extracted from at least one of a driving style of the driver, a driving habit of the driver, and a driving posture of the driver acquired by analyzing a camera image.

3. The method of claim 1, wherein the determining the skill status of the driver comprises:
extracting feature values from the driving information acquired through at least one sensor;
inputting the feature values to an artificial neural network (ANN) classifier trained to distinguish the skill status of the driver; and
determining the skill status of the driver based on an output of the ANN classifier.

4. The method of claim 3, wherein the feature values include information on at least one of a quick start, a sudden stop, a speed violation, a lane change, an acceleration, a sudden deceleration, a vibration strength, and a vibration number.

5. The method of claim 1, further comprising:
in response to determining that the skill status of the driver is lower than the predetermined reference, acquiring road information and sensing information collected in real time and executing a control function to guide the AI mobility device to a safe region excluding a preset danger zone.

6. The method of claim 1, wherein the applying the road information corresponding to the skill status of the driver comprises:
setting road information for a beginner type of driver when the skill status of the driver is determined to correspond to the beginner type of driver;
setting road information for an intermediate type of driver when the skill status of the driver is determined to correspond to the intermediate type of driver; and
setting road information for an advanced type of driver when the skill status of the driver is determined to correspond to the advanced type of driver.

7. The method of claim 6, further comprising:
in response to determining that the skill status of the driver is lower than the predetermined reference, transitioning the AI mobility device from a manual driving mode to an artificial intelligence (AI) driving mode; and
moving the AI mobility device to a safe region using the AI driving mode, depriving an authority of the driver to control driving of the AI mobility device, or resetting a driving mode of the AI mobility device to correspond to the skill status of the driver.

8. The method of claim 1, further comprising:
in response to determining that an accident occurs while the AI mobility device is being driven, detecting a location of the accident by a sensor disposed in the AI mobility device; and
transmitting the location of the accident and a notification to a preset guardian associated with the driver or the AI mobility device.

9. The method of claim 1, further comprising:
transmitting a vehicle-to-everything (V2X) message to a device communicatively connected to the AI mobility device, the V2X message including information related to a driving state of the driver.

10. The method of claim 1, further comprising:
receiving, from a network, downlink control information (DCI) used for scheduling transmission of the driving information of the driver acquired from at least one sensor,
wherein the driving information of the driver is transmitted to the network based on the DCI.

11. The method of claim 10, further comprising:
performing an initial access procedure with the network based on a synchronization signal block (SSB),
wherein the driving information of the driver is transmitted to the network via a physical uplink shared channel (PUSCH), and
wherein the SSB and a demodulation reference signal (DM-RS) of the PUSCH are quasi-co-located (QCL) for a QCL type D.

12. The method of claim 11, further comprising:
controlling a transceiver to transmit the driving information of the driver to an AI processor included in the network; and
controlling the transceiver to receive AI-processed information from the AI processor.

13. The method of claim 1, further comprising:
receiving an image of a road in front of the AI mobility device from a camera in the AI mobility device; and
executing a function based on the image, the function executed based on the image including at least one of sending a notification to an external device or decelerating the AI mobility device.

14. An intelligent computing device for controlling an artificial intelligence (AI) mobility device, the intelligent computing device comprising:
a camera configured to capture an image of surroundings of the AI mobility device;
a sensor configured to sense driving information associated with the AI mobility device; and
a processor configured to:
acquire personal information of a driver of the AI mobility device and set a driving level based on the personal information of the driver,
acquire driving information of the driver from the sensor based on the driving level while the driver is driving,
determine a skill status of the driver based on the driving information of the driver,
apply road information corresponding to the skill status of the driver, and
in response to determining that the skill status of the driver is lower than a predetermined reference based on the road information, output a warning and output a control signal to execute a function of the AI mobility device based on the warning.

15. The intelligent computing device of claim 14, wherein the processor is further configured to:
extract feature values from the driving information of the driver acquired through the sensor,
input the feature values to an artificial neural network (ANN) classifier trained to distinguish the skill status of the driver, and
determine the skill status of the driver based on an output of the ANN.

16. The intelligent computing device of claim 15, further comprising:
a transceiver,
wherein the processor is further configured to:
transmit, via the transceiver, the driving information of the driver to an AI processor included in the network and receive AI-processed information from the AI processor, and
wherein the AI-processed information is information for determining the skill status of the driver.

17. The intelligent computing device of claim 14, wherein the processor is further configured to:
map sensing information acquired through the sensor to map information,
extract road information and information of a region including a dangerous factor for the AI mobility device to drive, based on the map information, and
set a region of interest (ROI) for object tracking based on the information of the region including the dangerous factor for the AI mobility device to drive,
wherein the ROI includes a geographical range to be monitored for the AI mobility device to drive.

18. The intelligent computing device of claim 14, wherein the processor is further configured to:
set road information for a beginner type of driver when the skill status of the driver is determined to correspond to the beginner type of driver,
set road information for an intermediate type of driver when the skill status of the driver is determined to correspond to the intermediate type of driver, and
set road information for an advanced type of driver when the skill status of the driver is determined to correspond to the advanced type of driver.

19. The intelligent computing device of claim 14, wherein the processor is further configured to:
in response to determining that an accident occurs while the AI mobility device is being driven, detect a location of the accident by the sensor, and
transmit the location of the accident and a notification to a preset guardian associated with the driver or the AI mobility device.

20. The intelligent computing device of claim 14, wherein the processor is further configured to:
receive an image of a road in front of the AI mobility device from the camera, and
output a control signal for executing a function based on the image for sending a notification to an external device or for decelerating the AI mobility device.
